(19) United States
(12) Patent Application Publication
(10) Pub. No.: US 2026/0135329 A1
(43) Pub. Date: May 14, 2026

(54) PLUG CONNECTOR AND CIRCUIT BOARD HAVING SUCH A PLUG CONNECTOR

(71) Applicant: MD ELEKTRONIK GmbH, Waldkraiburg (DE)

(72) Inventor: Daniel BOCK, Schönberg (DE)

(73) Assignee: MD ELEKTRONIK GmbH, Waldkraiburg (DE)

(21) Appl. No.: 19/362,534

(22) Filed: Oct. 20, 2025

(30) Foreign Application Priority Data
Nov. 11, 2024 (DE) 10 2024 132 913.0

(51) Int. Cl. H01R 13/52; H01R 12/72; H01R 13/631

(52) U.S. Cl. CPC H01R 13/5219; H01R 12/722; H01R 13/5202; H01R 13/631

(57) ABSTRACT

A plug connector for a sealed plug connection includes a contact arrangement arranged in a main body of the plug connector and plugged in from a plug-in direction of the contact arrangement from a front face of the main body. The main body forms a plug-in plug face of the plug connection which is plugged in and surrounds the contact arrangement. The plug face is formed as a depression in the front face, and a collar which is arranged around an outer conductor contact of the contact arrangement projects into the depression in the plug-in direction. Flank faces of the depression form an outer contour of the plug face, and the collar and the flank faces are connected to one another in a fluid-tight manner by a base of the depression.

### FIELD

The present invention relates to a plug connector for a sealed plug connection and to a circuit board having a corresponding plug connector.

### BACKGROUND

A plug connection may be exposed to environmental influences. Environmental influences, in particular penetrating liquids, may lead to corrosion and impede a transmission of electric current via plug contacts of the plug connection. This impediment may disrupt a signal transmission and/or an energy transmission via the plug connection.

In order to keep the environmental influences away from the plug connection, the plug connection may be displaced into a sealed housing of a component connected by the plug connection. For example, a cable bushing of the housing may be sealed, so that unsealed plug connectors may be used in the housing.

Alternatively, the plug connection may be arranged in a sealed, divided plug housing. In this case, two unsealed plug connectors may be connected to one another in the plug housing and a sealing mechanism of the plug housing may be actuated subsequently or also in the same step. For example, a seal surrounding the plug connection may be pressed against a corresponding sealing surface or a further seal via a wedge effect of a thread or at least of a locking lever.

The production of the sealed plug connection in each case requires an additional action for sealing.

### SUMMARY

There may be a need for a sealed plug connection which may be connected in a simple and reliable manner and seals without a sealing mechanism which is additionally to be operated. In particular, there may be a need for a plug connector for forming such a plug connection. Furthermore, there may be a need for a circuit board having a corresponding plug connector.

Such a need may be met by the subject matter of the independent claims. Advantageous embodiments are set out in the dependent claims, the following description and the appended figures.

A first aspect of the invention relates to a plug connector for a sealed plug connection, wherein the plug connector has a contact arrangement which is arranged, in particular cast-in, in a main body of the plug connector and may be plugged in from a plug-in direction of the contact arrangement from a front face of the main body. In this case, the main body forms a plug-in plug face of the plug connection which plug face may be plugged in and surrounds the contact arrangement, wherein the plug face is formed as a depression in the front face. A collar which is arranged around an outer conductor contact of the contact arrangement projects into the depression in the plug-in direction, wherein flank faces of the depression form an outer contour of the plug face. The collar and the flank faces are connected to one another in a fluid-tight manner by a base of the depression. The collar has, on an outer side, and/or the flank faces have, on an inner side, a sealing face which is oriented substantially in the plug-in direction for sealing on a sealing element of a mating plug connector of the plug connection.

Without restricting the scope of the invention in any way, ideas and possible features relating to embodiments of the invention may be regarded, inter alia, as being based on the concepts and observations described below.

A plug connector may be plugged together with a mating plug connector to form a plug connection. The plug connection may be disconnected again, that is to say may be reversible. The plug connector may have a predefined plug-in direction which may be defined, inter alia, by guide faces of the plug connector and of the mating plug connector. The plug connector and the mating plug connector may be plugged together axially in the plug-in direction and disconnected again.

The guide faces may be a constituent part of a plug face of the plug connector. The plug face may have a shape which is characteristic of the respective plug connection. The plug connector described here may be referred to, in particular, as a socket or female part of the plug connection since the plug face is formed substantially as a depression or recess and may receive an elevation or a projection of the mating plug connector. The mating plug connector may therefore be plugged into the plug connector in order to form the plug connection. The mating plug connector may consequently be referred to as a plug or male part of the plug connection.

A contact arrangement may consist of electrically conductive contact elements, electrically insulating insulator material and an electrically conductive outer conductor contact. The contact elements and the outer conductor contact may consist of a metal material. The contact elements may be arranged within the outer conductor contact. The contact elements may be electrically insulated from one another and from the outer conductor contact by the insulator material. The outer conductor contact may be used as a shield against electromagnetic coupling-in and coupling-out. The outer conductor contact may be connected to a ground potential. The outer conductor contact may be mechanically more stable than the contact elements, for example on account of an increased material thickness and/or a stiffening geometry. The outer conductor contact may lead the contact elements. The outer conductor contact may serve as a guide element of the contact arrangement and predefine the plug-in direction. The outer conductor contact may enclose the electrical conductors radially with respect to the plug-in direction.

A main body may consist of an electrically non-conductive plastic material. The main body may be an electrical insulator. The main body may be produced by injection molding. The contact arrangement may be inserted as an insert part into a tool for producing the main body and subsequently be embedded in plasticized plastic material which subsequently hardens around the contact arrangement. Alternatively, the contact arrangement may be pushed or pressed into a recess of the main body after the injection molding of the main body. The main body may have lifting bevels or demolding bevels for demolding from the tool. The lifting bevels may have different directions depending on a configuration of the tool. The plug face may also have lifting bevels.

A collar may radially enclose the contact arrangement. The collar may substantially follow a contour of the outer conductor contact. The collar may be cast onto the contact arrangement during the injection molding or the contact arrangement may subsequently be pressed or pushed into an interior of the collar.

A sealing surface may be smooth or have a roughness less than a maximum value. A sealing element of the mating plug connector may be, in particular, an elastic seal. The sealing element may be annular or long-annular or elliptical and, in the connected state of the plug connection, bear circumferentially against the sealing face or may be slightly squeezed between the sealing face of the plug connector and a corresponding sealing face of the mating plug connector. The sealing face may be arranged on the collar. The sealing element may then be arranged in the interior of the mating plug connector and may be well protected there, for example, from contact and from soiling. Alternatively or additionally, the sealing face may be arranged on the flank faces. A sealing element arranged on the mating plug connector would thus be arranged on an exposed outer side of the mating plug connector. The sealing element may therefore also be arranged in a well-protected manner in the depression of the plug connector and may thus be part of the plug connector. The arrangement of the sealing face on the collar is therefore preferred, but the arrangement of the sealing face on the flank faces is also possible. The sealing element may have, for example, a plurality of parallel sealing ribs. The sealing element may be pushed onto the sealing face on the collar or the flank faces in the plug-in direction upon connecting the plug connection.

A base of the depression may be oriented substantially orthogonally with respect to the plug-in direction. The base may run around the collar in an annular manner. The base may delimit a plug-in depth of the plug connection. The base may serve as a stop face for the mating plug connector.

The flank faces may be arranged around the base and may be oriented substantially in the plug-in direction. The flank faces may be guide faces of the plug connection. The mating plug connector may only be plugged into the plug connector if its plug face may slide into the plug face of the plug connector in a collision-free manner.

The contact arrangement may be connected to a cable or an in particular multi-core electric line. An end region of the cable may be inserted or embedded into the main body.

The contact arrangement may preferably be configured in particular to be connected to a circuit board oriented in the plug-in direction and may have a circuit board interface angled transversely with respect to the plug-in direction. A circuit board may be referred to as a conductor plate or printed circuit board (PCB). The circuit board may be of a planar, i.e. substantially two-dimensional, structure. The circuit board interface may be formed as a soldering interface for connection by a soldering process. Contact elements of the circuit board interface may be electrically conductively connected to the corresponding contact elements of the contact arrangement within the contact arrangement. The circuit board interface may be shielded by a lateral extension of the outer conductor contact. For example, the circuit board interface may have, as contact elements, soldering areas which may be placed onto corresponding soldering areas of the circuit board after a solder paste has been metered onto the soldering areas. The solder paste may subsequently preferably be melted by reflow soldering. Alternatively, the circuit board interface may have, as contact elements, contact pins which are inserted into corresponding contact bores of the circuit board. The contact pins may subsequently be connected to the contact bores, for example, by flow soldering.

The circuit board interface may have alignment elements. The alignment elements may align the circuit board interface when the plug connector is placed onto a corresponding interface of the circuit board. After soldering, the alignment elements may serve as mechanical connectors between the plug connector and the circuit board. Alternatively or additionally, the alignment elements may be used as ground contacts between the outer conductor contact of the contact arrangement and the circuit board.

A second aspect of the invention relates to a circuit board having a plug connector according to an embodiment of the first aspect, wherein an angled circuit board interface of the contact arrangement is connected to conductor tracks of the circuit board next to an edge of the circuit board, wherein at least one part of the main body is arranged between a surface of the circuit board and the outer conductor contact.

The part of the main body which is arranged between the outer conductor contact and the circuit board ensures fluid-tightness of the plug face. In this case, the circuit board interface projects beyond the outer conductor contact at least to such an extent that the part of the main body fits between the outer conductor and the circuit board.

The circuit board interface may project beyond the outer conductor contact transversely with respect to the plug-in direction by between one millimeter and ten millimeters, preferably by one to five millimeters. In this case, a projecting part of the circuit board interface may be embedded into the main body behind the plug face. In comparison with a standard contact arrangement for circuit boards, the circuit board interface may project further laterally beyond the outer conductor contact here. By means of a large projection in the region of the five millimeters, parts of the collar, of the base and of the flank faces may be arranged between the circuit board and the outer conductor contact. As a result, the mating plug connector may be of stepless design at this point and contact safety (which is sometimes also referred to as Koshiri safety) of the mating plug connector may be improved.

The circuit board interface may be arranged spaced apart from a depth stop of the contact arrangement in the plug-in direction by between one millimeter and ten millimeters, preferably by one to five millimeters. The contact arrangement or the outer conductor contact may be embedded in the main body at least between the depth stop and the circuit board interface. A depth stop may be a plug-in depth limiter of the contact arrangement. The outer conductor contact and the contact elements of the contact arrangement may be extended axially in the plug-in direction here in relation to a standard contact arrangement for circuit boards. As a result, the outer conductor contact and the contact elements may project further beyond the edge of the conductor plate and the base of the plug face may be arranged substantially laterally next to the circuit board. As a result, too, the mating plug connector may be of stepless design and contact safety of the mating plug connector may be improved.

The contact arrangement may be, in particular, a USB-C socket or have a USB-C socket. A USB-C plug connection composed of a USB-C socket and a USB-C plug is configured to transmit high-frequency data or signal flows. In this case, the USB-C plug connection generally has to meet high and strictly standardized requirements in respect of both its structural properties and its functional properties. In particular, high-frequency data or signal flows typically have to be made possible and, in this case, disturbances such as, for example, crosstalk, emission or coupling-in of electromagnetic radiation and the like have to be minimized.

A USB-C plug connection is not fluid-tight without additional sealing measures. The plug connector presented here provides these sealing measures. The sealing may take place directly during the plugging together of the plug connector and the mating plug connector by virtue of the sealing element being pushed or pressed onto the sealing face of the collar during the plug-in movement along the plug-in direction.

The main body may form a sealing region, which runs around the plug face or the front face, for sealing on a housing. The plug connector may be referred to as a housing plug connector. The plug connector may be arranged in a cutout of the housing. The sealing region may seal on a contour of the cutout. For this purpose, the sealing region may have, for example, a flange which is oriented transversely with respect to the plug-in direction and may bear against an outer side or inner side of the housing and may define an axial position of the plug connector with respect to the housing. Alternatively or additionally, the sealing region may have a circumferential sealing face which is oriented in the plug-in direction and is shaped in accordance with the cutout. A sealing material may be arranged between the flange and/or the sealing face in order to produce the fluid-tightness. For example, the plug connector may be adhesively bonded into the cutout.

The main body may have a counterweight for balancing the plug connector on a side which faces away from the front face. The counterweight may be an additional accumulation of material without a direct function for the plug connection. The counterweight may provide a weight force which compensates for a weight force by means of an accumulation of material in the region of the plug face. As a result of the counterweight, the plug connector may be arranged on the edge of the circuit board without the weight force of the plug face leading to tilting of the plug connector over the edge. The counterweight may consist of the plastic material of the main body. The counterweight may be, in particular, heavier than the plug face in order to make possible an overall center of gravity of the plug connector over the circuit board.

The flank faces and/or the collar may form at least one coding device, which is oriented in the plug-in direction, of the plug face. A coding device may be a coding groove or a coding rib. A coding rib may penetrate into a corresponding coding groove on the other part of the plug connection during the plugging together. If no matching coding groove is present at this point, a collision occurs and the plug connection may not be plugged in at least in the current orientation. A rotation, for example, of the mating plug connector through 180° is possibly required in order to bring the coding rib together with a matching coding groove. The production of an incorrect plug connection may be prevented by coding devices. In particular in the case of a plurality of plug connections lying next to one another, errors may thus be avoided. The coding may also be optically supported by a coloring of the plug connector and mating plug connector.

The flank faces of the depression may at least partially form a latching device of the plug face. A latching device may make possible a mechanical connection between the plug connector and the mating plug connector. The latching device may be formed, in particular, as an undercut for a resiliently latching latching lug on the mating plug connector. The latching device may have, in particular, a recess for a spring of the latching lug. The latching device may additionally act as an anti-rotation means of the plug connection.

The latching device may project at least partially out of the front face. For this purpose, the latching device of the mating plug connector may be arranged set back in the plug-in direction. In particular, a structure with the undercut may project out of the front face.

The collar may stand back behind the front face. As a result of standing back or being arranged offset in the plug-in direction in the direction of the contact arrangement, the plug face of the mating plug may first touch the flank faces of the depression and may be oriented thereon before the collar comes into contact with the sealing element. As a result, a lateral offset and a rotation of the sealing element with respect to the sealing face on the collar may be prevented. Damage to the sealing face and to the sealing element may be prevented.

The collar may project beyond the outer conductor contact and the contact arrangement. As a result, inadvertent contact to the outer conductor contact and the contact arrangement may be prevented.

The base may have a step. As a result, the flank faces on one side of the contact arrangement may be shorter than on an opposite side of the contact arrangement. As a result of the step, the circuit board interface of the contact arrangement may project laterally beyond the outer conductor contact transversely with respect to the plug-in direction by between one millimeter and two millimeters. The step may make possible the use of a contact arrangement with an axial distance of the depth stop from the circuit board interface of between 0.5 and five millimeters. When the circuit board interface is arranged on the surface of the circuit board, the edge of the circuit board may be arranged behind the step of the base. As a result of the step, the mating plug connector may likewise have a step.

The collar with the outer conductor contact may project at least partially beyond the edge. At least a portion of the base of the plug face may be arranged in front of or laterally next to the edge. The portion of the base may be formed by the step. In the case of a base without a step, a contact arrangement extended in the plug-in direction may be used.

The main body may have a counterweight with respect to the plug face. The counterweight may have a bearing face which is arranged on the surface of the circuit board. Contact elements of the circuit board interface may be arranged in a plane of the bearing face. The counterweight and the circuit board interface may have a continuous bearing face with respect to the circuit board. As a result, before soldering, the plug connector may be arranged in a simple manner on the circuit board without tilting.

The counterweight may be mechanically connected to the circuit board using at least one fastening element. A fastening element may project beyond the bearing face of the counterweight and be arranged in a bore of the circuit board. The fastening element may, in particular, dissipate forces in the plug-in direction from the plug connector to the circuit board and thus relieve the circuit board interface of these forces. The fastening element may be without an electrical function. The fastening element may be cast onto the counterweight. Alternatively, the fastening element may be an injection-molded insert part. The fastening element may then be made of a metal material and may be connected to the circuit board by a soldering point during soldering. The fastening element may also be a plug-in part which is arranged in a receptacle of the counterweight before the circuit board is fitted. In particular, the counterweight may have a plurality of fastening elements to which the force in the plug-in direction and other forces are distributed.

It is pointed out that possible features and advantages of embodiments of the invention are described partly with reference to a plug connector or a plug connection formed therewith and partly with reference to a circuit board having a corresponding plug connector. A person skilled in the art will recognize that the features described for individual embodiments may be transferred, adapted and/or exchanged in an analogous and suitable manner to other embodiments in order to arrive at further embodiments of the invention and possibly at synergy effects.

### BRIEF DESCRIPTION OF THE DRAWINGS

Advantageous embodiments of the invention are explained further below with reference to the appended drawings, wherein neither the drawings nor the explanations are to be interpreted as limiting the invention in any way.

FIGS. 1 to 3 show sectional illustrations of plug connectors according to exemplary embodiments.

FIG. 4 shows an illustration of a plug connector according to an exemplary embodiment.

The figures are merely schematic and not true to scale. Identical reference signs denote identical or identically acting features in the various drawings.

### DETAILED DESCRIPTION

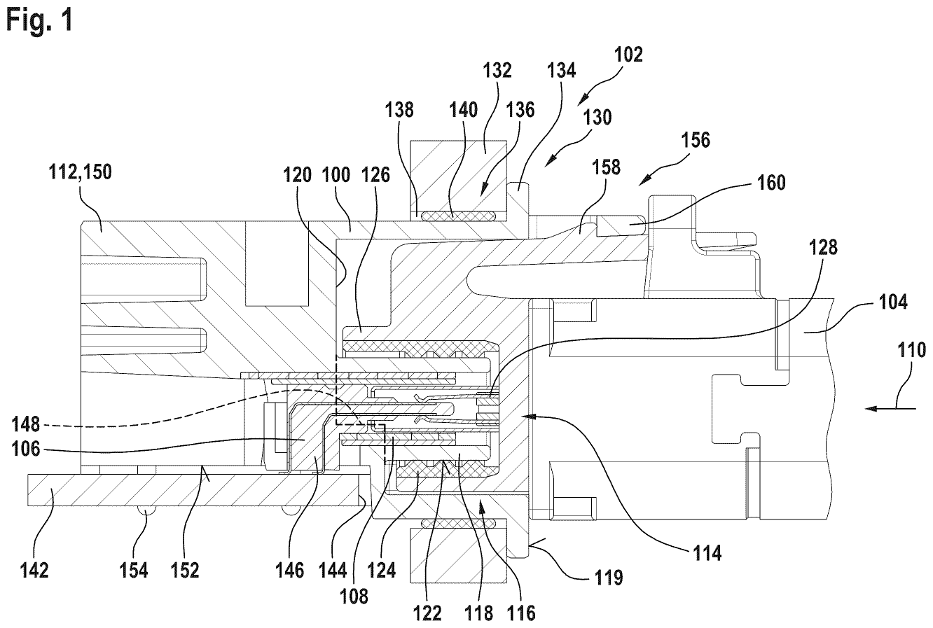

FIG. 1 shows a sectional illustration of a plug connector 100 according to an exemplary embodiment having a mating plug connector 104 plugged together to form a sealed plug connection 102. The plug connector 100 has a cast-in contact arrangement 106 having a plurality of contact elements and an outer conductor contact 108. The outer conductor contact 108 encloses the contact elements in an annular manner and predefines a plug-in direction 110 of the plug connection. The outer conductor contact 108 is made of a metal material. The contact arrangement 106 is cast into a main body 112 made of a plastic material. The contact arrangement 106 is accessible in the main body 112 from the plug-in direction 110 and may be plugged in.

The main body 112 forms a plug face 114 of the plug connector 100 which plug face 114 surrounds the contact arrangement 106. The plug face 114 has flank faces 116 which are oriented substantially in the plug-in direction 110 and a central collar 118 which is oriented in the plug-in direction 110 and encloses the contact arrangement 106. The plug face 114 is thus a depression, which is arranged between the flank faces 116 and the collar 118 and runs around the collar 118 in an annular manner, in a front face 119 of the main body 112. A base 120 of the depression is continuous and fluid-tight.

The collar 118 has, on its outer side, a sealing face 122 which is oriented in the plug-in direction and runs around in an annular manner. An annular sealing element 124 of the mating plug connector 104 seals on the sealing face 122. The sealing element 124 is arranged on an inner side of a tubular projection 126, which protrudes from the mating plug connector 104, of a mating plug face of the mating plug connector 104. In the plugged-in state of the plug connection 102, the projection 126 is arranged in the annular depression of the plug face 114. Outer sides of the projection 126 bear against the flank faces 116. In the interior of the projection 126, a mating contact arrangement 128 of the mating plug connector 104 projects out of a base of the mating plug face. The mating contact arrangement 128 is plugged into the outer conductor contact 108 and makes electrical contact with the contact elements arranged in the outer conductor contact 108. The contact arrangement 106 is, in particular, a USB-C socket here.

In one exemplary embodiment, the plug connector 100 is configured as a housing socket, while the mating plug connector 104 is formed as a cable plug. For this purpose, a connection region 130 of the plug connector 100 runs around the front face 119 to a housing 132, for example of a control unit. The connection region 130 comprises, here, a flange 134 oriented transversely with respect to the plug-in direction 110 and an adjoining sealing region 136 oriented in the plug-in direction 110. Here, a sealing material 140, such as, for example, an adhesive, is arranged between the sealing region 136 and a cutout 138 of the housing 132. Alternatively or additionally, the sealing material 140 may also be arranged between the flange 134 and the housing 132.

In one exemplary embodiment, the plug connector 100 is arranged on a circuit board 142 within the housing 132. The plug connector 100 is arranged close to an edge 144 of the circuit board on a surface of the circuit board 142. The circuit board 142 is oriented in the plug-in direction 110. The circuit board 142 is arranged offset laterally with respect to the outer conductor contact 108. The contact arrangement 106 has, for connection to conductor tracks of the circuit board 142, a circuit board interface 146 angled transversely with respect to the plug-in direction 110. The circuit board interface 146 projects laterally beyond the outer conductor contact 108 to such an extent that a part of the plug face 114 has space between the outer conductor contact 108 and the circuit board 142. In particular, a part of the collar 118 is arranged around the outer conductor contact 108 between the outer conductor contact 108 and the circuit board 142. In the exemplary embodiment illustrated, the circuit board interface 146 projects laterally beyond the outer conductor contact 108 by approximately 1.8 millimeters. In addition, the circuit board interface 146 is arranged set back in the plug-in direction 110 by approximately 1.5 millimeters behind a depth stop of the contact arrangement 106. The dimensions mentioned above and also mentioned further below with reference to other embodiments may also be selected to be greater or smaller within certain limits or tolerances, for example by +10%, +20% or even ±50%. In this case, however, it should be ensured that, in the case of strong deviations from the values mentioned, a functionality of the plug connection such as, for example, a shield influenced by the dimensions mentioned and/or crosstalk within the plug connection should not be excessively influenced.

In one exemplary embodiment, the plug connector 100 is arranged so close to the edge 144 that a large part of the plug face 114 is arranged laterally next to the circuit board 142, that is to say projects beyond the edge 144. Here, the base 120 of the depression has a step 148, by means of which the base 120 stands back above the edge 144 behind the edge 144, while the base 120 is arranged in the extension of the circuit board 142 next to the edge 144. The flank faces 116 project for the most part beyond the edge 144.

In one exemplary embodiment, the plug connector 100 has a counterweight 150. The counterweight 150 consists of plastic material of the plug connector 100 and is arranged on the surface of the circuit board 142. The counterweight 150 balances the plug face 114 projecting beyond the edge 144, so that when the circuit board 142 is fitted, the plug connector 100 lies stably on the surface without tilting over the edge 144. The counterweight 150 has a bearing face 152 with respect to the circuit board 142. The bearing face 152 is arranged in a plane with the circuit board interface 146.

In one exemplary embodiment, the counterweight 150 is connected to the circuit board 142 by at least one fastening element 154. Here, the fastening element 154 is made of a metal material and subsequently pressed into the counterweight 150. The metal fastening element 154 may be mechanically connected to the circuit board 142 during soldering of the plug connector 100.

In one exemplary embodiment, the flank faces 116 at least partially form a latching device 156 of the plug connector 100. The latching device 156 receives a mating latching device of the mating plug 104 and, in the plugged-in state, forms a form-fitting connection to the mating latching device. The latching device 156 and mating latching device are formed, for example, as a resilient latch 158 and undercut 160. During the plugging-in of the mating plug connector 104, the latch 158 is elastically deformed during sliding over the undercut 160 and springs back again after the undercut 160 and latches in. As a result, it is only possible to separate the plug connection 102 if the latch 158 and/or the undercut 160 are previously deformed again in order to release the latching device 156.

In one exemplary embodiment, part of the latching device 156 of the plug connector 100 projects out of the front face 119 in the plug-in direction 110. As a result, the latching device 156 of the mating plug connector 104 is arranged set back in the plug-in direction 110. As a result, the flank faces 116 only form a guide contour for the latching device 156 of the mating plug connector 104. The guide contour in this case additionally serves as an anti-rotation means of the plug connection 102.

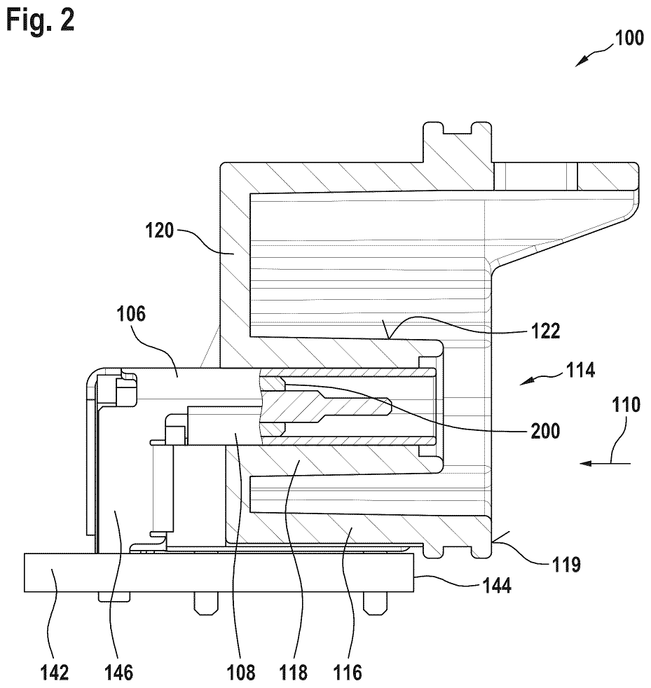

FIG. 2 shows a sectional illustration of a plug connector 100 according to an exemplary embodiment. The plug connector 100 in this case substantially corresponds to the plug connector in FIG. 1. In contrast thereto, the circuit board interface 146 is connected to the circuit board 142 further away from the edge 144. For this purpose, the circuit board interface 146 projects further laterally beyond the outer conductor contact 108 than in FIG. 1. As a result, here both a part of the collar 118 and a part of the flank faces 116 are arranged between the outer conductor contact 108 and the circuit board 142. The plug face 114 is as a result arranged virtually completely over the surface of the circuit board 142. Only the front face 119 of the plug connector 100 is arranged next to the edge 144. In the exemplary embodiment illustrated, the circuit board interface 146 projects laterally beyond the outer conductor contact 108 by approximately 4.4 millimeters.

In one exemplary embodiment, the circuit board interface 146 is additionally arranged set back in the plug-in direction 110 by approximately 4.45 millimeters behind the depth stop 200 of the contact arrangement 106.

In the exemplary embodiment illustrated, the plug connector 100 has no counterweight for balancing the plug face 114 since the plug connector 100 lies virtually completely on the circuit board 142.

In one exemplary embodiment, the plug face 114 has a stepless base 120. As a result of the step being omitted, the mating plug connector may be designed with increased contact safety.

In one exemplary embodiment, the contact arrangement 106 projects behind a front edge of the collar 118 in order to ensure contact safety of the plug connector 100. The front edge of the collar 118 in turn projects behind the front face 119. As a result, the projection of the mating plug connector first touches the flank faces 116 and is oriented on the plug face 114 before the sealing element slides onto the sealing face 122, and the mating contact arrangement dips into the collar 118 and produces electrical contact.

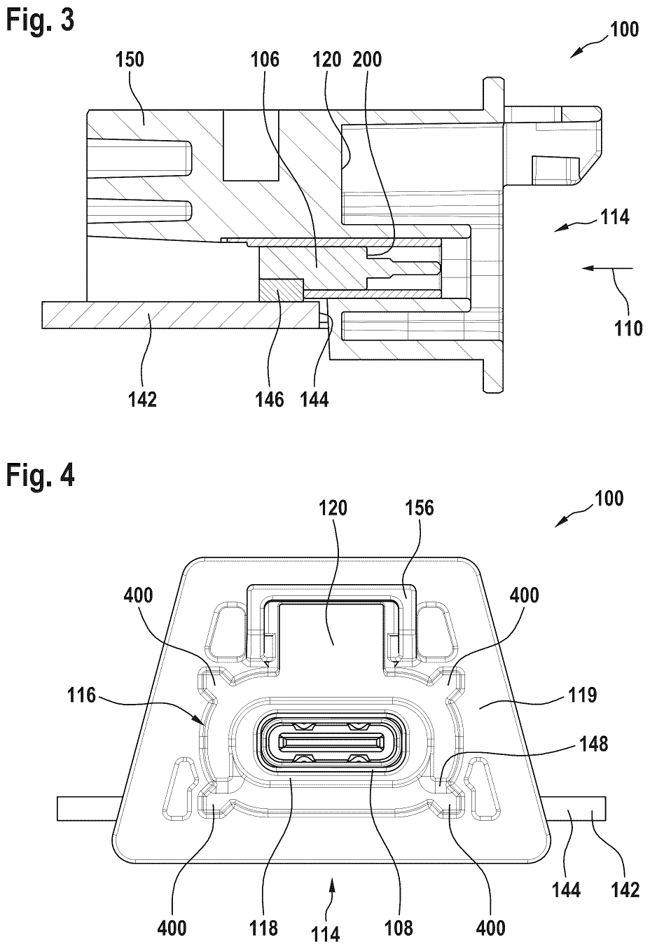

FIG. 3 shows a sectional illustration of a plug connector 100 according to an exemplary embodiment. The plug connector 100 substantially corresponds to the plug connector 100 in FIG. 1. As in FIG. 1, the plug connector 100 has a counterweight 150 arranged above the circuit board 142 in order to displace a center of gravity of the plug connector 100 over the surface of the circuit board 142. As in FIG. 1, the circuit board interface 146 is connected to the circuit board 142 at the edge 144. In contrast to FIG. 1, the circuit board interface 146 is arranged set back here in the plug-in direction 110 by approximately 4.45 millimeters behind the depth stop 200 of the contact arrangement 106. The contact arrangement 106 thus projects further beyond the edge 144 than in FIG. 1. As a result, the base 120 has no step and the plug face 114 is arranged completely next to the edge 144. Here too, the contact safety of the mating plug connector may be improved.

FIG. 4 shows an illustration of a plug connector 100 according to an exemplary embodiment. The plug connector 100 in this case substantially corresponds to one of the plug connectors in FIGS. 1 to 3. Here, a view in the plug-in direction of the front face 119 and the plug face 114 is illustrated.

In one exemplary embodiment, the base 120 has a step 148 as in FIG. 1. As a result of the step 148, a partial region of the base 120 is arranged in front of the edge 144 of the circuit board 142, while the rest of the base is arranged behind the edge 144.

The plug face 114 is designed substantially as a flattened round depression in the front face 119. The collar 118 projects centrally into the depression and is connected to the flank faces 116 in a fluid-tight manner via the base 120. The collar 118 seals against the outer conductor contact 108 in a fluid-tight manner.

In one exemplary embodiment, the flank faces 116 form at least one coding device 400 of the plug face 114. The coding devices 400 are in this case grooves arranged in a manner distributed around the plug face 114. However, the coding devices may also be ribs. Here, four coding devices 400 are illustrated. However, the plug face 114 may also have no, one, two or three coding devices 400 in differently coded variants. Likewise, grooves and ribs may be mixed.

In the case of a rib, the mating plug connector needs a matching or wider groove in order to be plugged in. In the case of a groove, the mating plug connector may have a matching or narrower rib or not. The plug connection may also be produced without a rib. In the case of a rib which is too wide, the plug connection may not be produced. The coding devices 400 may also be used as anti-rotation means in order to make possible plugging in only in one orientation. In the case of contact arrangements which may be plugged in in an axially symmetrical manner, such as USB-C, the coding devices 400 may alternatively also be of axially symmetrical design in order to also make possible plugging in which is rotated through 180°.

In one exemplary embodiment, the anti-rotation means is provided via the asymmetrically designed latching device 156. As a result, many differently coded plug connections may be defined using the coding devices 400.

Possible configurations of the invention are illustrated once again in a summarized manner or with a slightly different word selection.

A sealed female PCB connector is presented horizontally. The PCB connector presented is particularly suitable for the automobile industry.

Since USB-C plug systems were originally developed for the consumer market, no particular environmental requirements have been taken into account. In some installation situations in automobile or also commercial vehicle technology, however, it is necessary to produce a sealed plug connection—water-tight and/or dust-tight. Therefore, a sealed variant of an automotive USB-C plug system is presented here.

Most known USB-C plug systems are not suitable for a sealed application. Conventionally, a complex printed circuit board contour may additionally be required. For example, a protruding web may be required as a printed circuit board contour. This may increase the costs of printed circuit board production and/or reduce the mechanical stability. In addition, the Koshiri safety is not complied with in most known USB-C plug systems.

Therefore, a solution for a sealed application having a printed circuit board contour which is as simple as possible and corresponding to automotive requirements such as Koshiri safety, for example, is presented here.

For a printed circuit board contour which is as simple as possible when the plug connector is installed in a housing, no “standard USB-C socket” according to USB-C Spec., but an individualized “custom” USB-C socket is used. This differs in that it is raised, that is to say has an increased distance from the circuit board. In order that the printed circuit board edge may be set back, the front GND feet of the standard USB-C socket are removed on the individualized USB-C socket. Otherwise, these are mainly required for the mechanical strength. In the solution presented here, however, the mechanical strength is ensured via the injection-molded housing. In order that a watertight connection (together with the line plug) may be produced, the socket or the housing is completely “closed”.

Finally, it is pointed out that terms such as “having”, “comprising” etc. do not exclude any other elements or steps and terms such as “a” or “an” do not exclude a multiplicity. Furthermore, it is pointed out that features or steps which have been described with reference to one of the above exemplary embodiments may also be used in combination with other features or steps of other exemplary embodiments described above. Reference signs in the claims should not be regarded as a restriction.

### LIST OF REFERENCE SIGNS

100 plug connector
102 plug connection
104 mating plug connector
106 contact arrangement
108 outer conductor contact
110 plug-in direction
112 main body
114 plug face
116 flank face
118 collar
119 front face
120 base
122 sealing face
124 sealing element
126 projection
128 mating contact arrangement
130 connection region
132 housing
134 flange
136 sealing region
138 cutout
140 sealing material
142 circuit board
144 edge
146 circuit board interface
148 step
150 counterweight
152 bearing face
154 fastening element
156 latching device
158 latch
160 undercut
200 depth stop
400 coding device

1. A plug connector for a sealed plug connection, comprising:
a contact arrangement which is arranged, in particular cast, in a main body of the plug connector and may be plugged in from a plug-in direction of the contact arrangement from a front face of the main body,
wherein the main body forms a plug-in plug face of the plug connection which plug face may be plugged in and surrounds the contact arrangement,
wherein the plug face is formed as a depression in the front face,
wherein a collar which is arranged around an outer conductor contact of the contact arrangement projects into the depression in the plug-in direction,
wherein flank faces of the depression form an outer contour of the plug face, wherein the collar and the flank faces are connected to one another in a fluid-tight manner by a base of the depression and the collar has, on an outer side, and/or the flank faces have, on an inner side, a sealing face which is oriented substantially in the plug-in direction for sealing on a sealing element of a mating plug connector of the plug connection.

2. The plug connector according to claim 1,
wherein the contact arrangement is configured to be connected to a circuit board oriented in the plug-in direction and has a circuit board interface angled transversely with respect to the plug-in direction, wherein the circuit board interface projects beyond the outer conductor contact transversely with respect to the plug-in direction by between one millimeter and ten millimeters, preferably by one to five millimeters.

3. The plug connector according to claim 1,
wherein the contact arrangement is configured to be connected to a circuit board oriented in the plug-in direction and has a circuit board interface angled transversely with respect to the plug-in direction, wherein the circuit board interface is arranged spaced apart from a depth stop of the contact arrangement in the plug-in direction by between one millimeter and ten millimeters, preferably by one to five millimeters.

4. The plug connector according to claim 1,
wherein the contact arrangement is a USB-C socket.

5. The plug connector according to claim 1,
wherein the main body forms a sealing region, which runs around the plug face, for sealing on a housing.

6. The plug connector according to claim 1,
wherein the main body has a counterweight for balancing the plug connector on a side which faces away from the front face.

7. The plug connector according to claim 1,
wherein the flank faces and/or the collar form at least one coding device, which is oriented in the plug-in direction, of the plug face.

8. The plug connector according to claim 1,
wherein the flank faces at least partially form a latching device of the plug face.

9. The plug connector according to claim 8, wherein the latching device projects at least partially out of the front face.

10. The plug connector according to claim 1,
wherein the collar stands back behind the front face.

11. The plug connector according to claim 1,
wherein the collar projects beyond the outer conductor contact.

12. The plug connector according to claim 1,
wherein the base has a step.

13. A circuit board, comprising: a plug connector according to claim 1,
wherein an angled circuit board interface of the contact arrangement is connected to conductor tracks of the circuit board next to an edge of the circuit board, wherein at least one part of the main body is arranged between a surface of the circuit board and the outer conductor contact.

14. The circuit board according to claim 13,
wherein the collar with the outer conductor contact projects at least partially beyond the edge and at least a portion of the base of the plug face is arranged in front of the edge.

15. The circuit board according to claim 13,
wherein the main body has a counterweight with respect to the plug face, wherein the counterweight has a bearing face which is arranged on the surface of the circuit board, wherein contact elements of the circuit board interface are arranged in a plane of the bearing face.

16. The circuit board according to claim 15,
wherein the counterweight is mechanically connected to the circuit board using at least one fastening element.
